(19) United States
(12) Patent Application Publication
(10) Pub. No.: US 2003/0117499 A1
(43) Pub. Date: Jun. 26, 2003

(54) Docking station that enables wireless remote control of a digital image capture device docked therein

(76) Inventors: Mark J. Bianchi, Fort Collins, CO (US); Norman C. Pyle, Greeley, CO (US)

Correspondence Address: HEWLETT-PACKARD COMPANY, Intellectual Property Administration, P.O. Box 272400, Fort Collins, CO, 80527-2400, US

(21) Appl. No.: 10/027,972

(22) Filed: Dec. 21, 2001

(51) Int. Cl. H04N 5/232; H04N 5/225

(52) U.S. Cl. 348/211.2; 348/373; 348/211.4

(57) ABSTRACT

A system and method for allowing a user to control remotely a digital image capture device without wires. A docking station for receiving a digital image capture device is provided. The docking station includes a wireless receiver. A wireless remote controller for sending at least one command to the docking station is also provided. The docking station also has a communication interface for communicating with the digital image capture device when the image capture device is docked therein. The user employs the wireless remote controller to access one or more functions of the digital image capture device through the docking station.

### FIELD OF THE INVENTION

The present invention relates generally to digital cameras, and more particularly, to a docking station that enables wireless remote control of a digital image capture device docked therein.

### BACKGROUND OF THE INVENTION

We are in the midst of a digital photography revolution; where everyday more and more users are embracing digital cameras instead of the traditional film-based camera. There are many reasons why users have made the switch from traditional cameras to digital cameras. One reason is that digital cameras provide features that are unavailable with traditional cameras. Some benefits of digital cameras over traditional cameras include 1) instant gratification, 2) ease of sharing the pictures, and 3) PC-based digital darkroom capabilities.

First, a user receives instant feedback from a digital camera. For example, a user can view the pictures the moment that he/she shoots them. The user can then select the best pictures and delete the unwanted pictures without wasting money on developing film and printing photos that are of little or no value to the photographer.

Another benefit of digital cameras is that they facilitate the creation and sharing of digital memories. Since the digital photographs are already in electronic form, a user can readily share the pictures with others. For example, a user can electronically mail the pictures to friends and family or post the pictures to a web site so that others can view them. As electronic mail (e-mail) and the Internet have allowed people to share information with anyone in the world, digital photography enables people to make an instant visual connection.

For example, vacation memories may be shared with friends and family by creating a web site dedicated to the vacation. Photos of the new baby can be electronically mailed to friends and family. Digital pictures also provide the opportunity to have “instant” pictures of special occasions. For example, during an anniversary party for one's parents, one can take pictures of the event and then immediately print photos to send to guests the day after. Alternatively, one can even print the photos before the guests leave the special occasion.

Digital technology gives the user the opportunity to be a darkroom developer without the darkness and chemicals required by traditional film. A personal computer (PC) and a digital-imaging program provide a PC-based digital darkroom that enables a user to be a darkroom developer. Digital pictures are especially amenable to modification and manipulation in a digital darkroom.

The magic begins once a digital picture is loaded into a user's computer. A user can easily crop the photos to focus in on a subject. A user can also make flaws (e.g., eyes that appear to be red) in the picture magically disappear or remove a distracting object from the background. Furthermore, a user can cut and paste portions of a first picture into a second picture to create special effects. Once the user has the picture with the desired modifications, if any, the user simply prints the picture.

As the popularity of digital cameras grows, manufacturers of digital cameras are constantly striving to improve the camera design and user interface design and to add features that are not offered by film cameras. Mechanisms and features that make the camera easier to use or that provides features that are useful to the photographer are in demand.

An important design consideration in digital cameras is how to allow users to view and share the pictures before they are downloaded to a personal computer (PC). For example, when pictures are stored in the cameras, many digital still cameras (DSCs) provide a display that is mounted to the back of the cameras for viewing the captured images. Unfortunately, these displays are small and often have limited viewing angles. Consequently, the user must hand the camera to each person who wishes to view the image. In this regard, it is difficult to discuss certain aspects of an image since all parties cannot view the image simultaneously. Also, the process of passing the camera around a room of people is cumbersome and inefficient.

In order to solve this problem, many current digital still cameras have an audio/video (A/V) output connector that is designed to connect to a television (TV) through a cable. The cable allows a user to review pictures on the TV screen, which is much larger than the small display on the camera. The use of a TV screen is certainly more convenient than having to pass the camera around the room for picture viewing purposes.

One disadvantage of this approach is that it requires the user to remain tethered to the TV through the ANV cable in order to access user interface functions through manipulation of the switches and buttons on the camera. Typical user interface functions include scrolling through still or video images, deleting unwanted pictures, and zooming in and zooming out of a particular region of interest in the picture.

Difficulty of accessing the A/V connectors of the TV is another disadvantage of this approach. Before a viewing session, a user must connect the A/V cable to the A/V connectors of the TV, which are often in a hard-to-access location in the back of the TV. Access is required both before and after the viewing session to connect and disconnect the A/V cable, respectively. This requirement places an annoying burden on the user.

Another problem is the need for long A/V cables to enable a user who is controlling the camera functions to be far enough away from the TV to have an adequate view of the TV. These long cables are an added cost to the user and may also pose a safety hazard (e.g., a trip hazard).

Some manufacturers of digital cameras have designed remote controls that are specifically designed for controlling their cameras. Although the remote control solves some of the problems inherent in using an A/V cable, the provision of a dedicated remote control increases the costs of the camera package. Furthermore, since there are space and cost constraints in the digital camera, it is typically a design challenge to incorporate IR receiver electronics in the camera.

Consequently, it would be desirable for there to be a mechanism to off-load the IR receiver electronics from the camera, to remove the cost burden of the IR receiver electronics from the digital camera, to simplify the digital camera design, and yet allow the sharing of images without the inconvenience of prior art approaches.

Based on the foregoing, there remains a need for a docking station for a digital camera that enables the wireless remote control thereof and that overcomes the disadvantages set forth previously.

### SUMMARY OF THE INVENTION

According to one embodiment, a system and method for allowing a user to remotely control without wires a digital image capture device (e.g., a digital camera). A docking station for receiving a digital image capture device is provided. The docking station includes a wireless receiver. A wireless remote controller for sending at least one command to the docking station is also provided. The docking station also has a communication interface for communicating with the digital image capture device when the capture device is docked therein. The user employs the remote controller to access one or more functions of the digital image capture device through the docking station.

Other features and advantages of the present invention will be apparent from the detailed description that follows.

### BRIEF DESCRIPTION OF THE DRAWINGS

The present invention is illustrated by way of example, and not by way of limitation, in the figures of the accompanying drawings and in which like reference numerals refer to similar elements.

FIG. 1 illustrates a system according to one embodiment of the present invention.

FIG. 2 is a block diagram illustrating in greater detail the system of FIG. 1 in accordance with one embodiment of the present invention.

FIG. 3 is a flow chart illustrating the operation of the system of FIG. 1 that employs the docking station to control the digital camera in accordance with one embodiment of the present invention.

FIG. 4 is a block diagram illustrating an alternative embodiment of a system present invention that employs a sound or voice recognition interface.

### DETAILED DESCRIPTION

A method and system that enables wireless remote control of an image capture device (e.g., a digital camera) when the image capture device is docked in a docking station is described. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

System 10

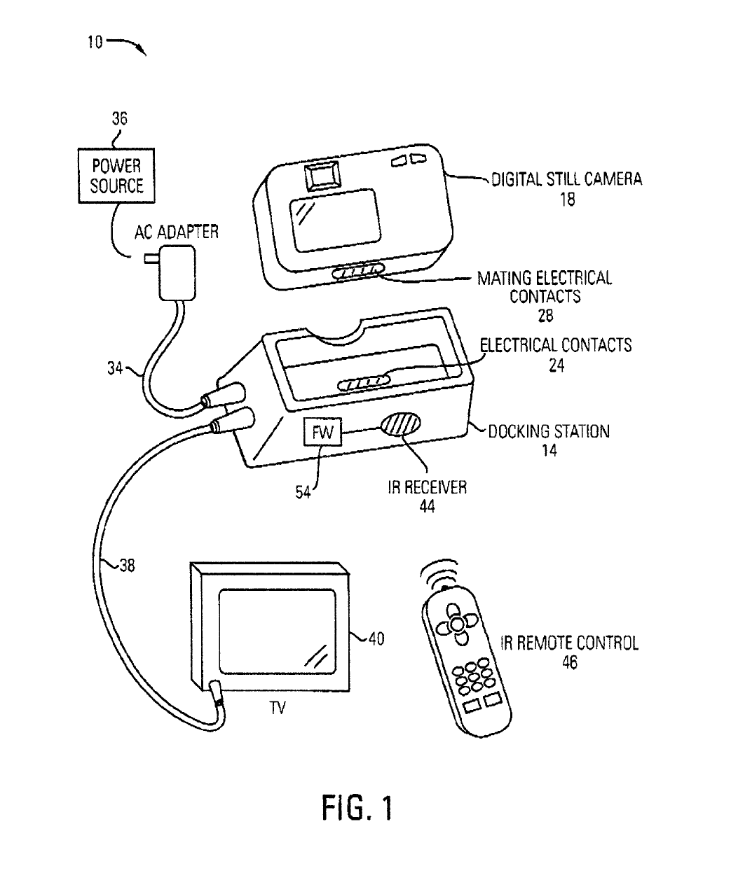

FIG. 1 illustrates a system 10 according to one embodiment of the present invention. The system 10 includes a docking station 14 (also referred to herein as a docking cradle 14) for mechanically and electrically mating with a digital image capture device 18 (e.g., a digital camera). The docking station 14 includes an electrical connector 24 with electrical contacts. The digital camera 18 includes an electrical connector 28 with electrical contacts for mating with the electrical contacts of the electrical connector 24 of the docking station 14. When the camera 18 is docked, the camera 18 is not in a picture-taking mode. Instead, the camera 18 is in a picture review mode.

Digital Image Capture Device 18

The image capture device 18 can include one or more functions. These functions can include image capture functions (e.g., picture taking functions) and user interface functions. The user interface functions can include those functions that provide feedback and those functions that do not provide feedback to the user. Functions that do not provide feedback to the user can include, but are not limited to, taking a picture, controlling the camera lens (e.g., zooming in and out as part of the picture-taking activity), and playing an audio clip, such as a .WAV file) associated with a picture.

Interface function that provide feedback (e.g., visual or audio feedback) can include, but are not limited to, viewing pictures, configuring settings of the camera, rotating a displayed picture, deleting a displayed picture, magnifying and panning within a selected picture, and other functions to manipulate captured images.

The digital image capture device 18 (e.g., digital camera) can have a plurality of buttons to activate one or more of the functions described previously. For example, camera 18 can include a menu button and a navigation button that can include a left arrow button, a right arrow button, a down arrow button and an up arrow button. The camera 18 can also have a select button for making a selection. These buttons are utilized for a variety of purposes.

For example, these buttons can be used to navigate through menu options, such as changing the volume of audio or changing the language in which the instructions or prompts are displayed. The left arrow button and the right arrow button may be utilized for picture review to cycle through the pictures in a slide-show fashion.

The digital camera can also include a display (e.g., a LCD screen) for displaying pictures and also a graphical user interface (GUI) for allowing a user to configure the camera or otherwise select options for display, etc.

The docking station 14 also preferably includes a cable 34 for receiving power from a power source 36. The digital camera 18 can include a DC input for receiving a predetermined operating voltage (e.g., 6V) from the cable 34. The docking station 14 can optionally include an audio/video (A/V) port for coupling to an A/V cable 38. The cable 38 can be connected to a separate display 40 (e.g., a television). Video and/or audio information can be directly transferred to a separate display device (e.g., a television) through the cable 38. Alternatively, the video and/or audio information can be communicated to a video recording device, such as, a Video Cassette Recorder (VCR) or Digital Video Recorder (DVR).

The digital camera 18 can include a battery compartment for receiving one or more batteries and a memory compartment for receiving a memory card for storing pictures. The digital camera 18 can also include a computer port for transferring information to a computer via a cable. The computer port can be, for example, a serial port or a Universal Serial Bus USB port.

Once the power cable 34 and the A/V cable 38 are connected, a user simply places the camera 18 into the docking cradle 14, and the camera 18 and docking cradle 14 are electrically connected. It is noted that the camera 18 receives its power from the docking station 14, and the station 14 may be equipped with a battery charger to re-charge the batteries of the camera 18.

Docking Cradle 14

The docking cradle 14 also preferably includes a wireless receiver 44, such as an infra-red (IR) receiver or a radio frequency (RF) receiver, for receiving commands from a remote control 46. The docking cradle 14 also includes firmware 54 that continuously monitors the wireless receiver's 44 output when the camera 18 is docked in the cradle 14. Specifically, when the contacts of the cradle 14 and camera 18 mate, the firmware 54 is informed that a camera 18 is docked. Once it is determined that a camera 18 is docked, the firmware 54 determines if the camera 18 by means of the docking station 14 needs to respond to commands that have been received by the receiver 44. In this manner, a user can access one or more functions (e.g., user interface functions) provided by the camera 18.

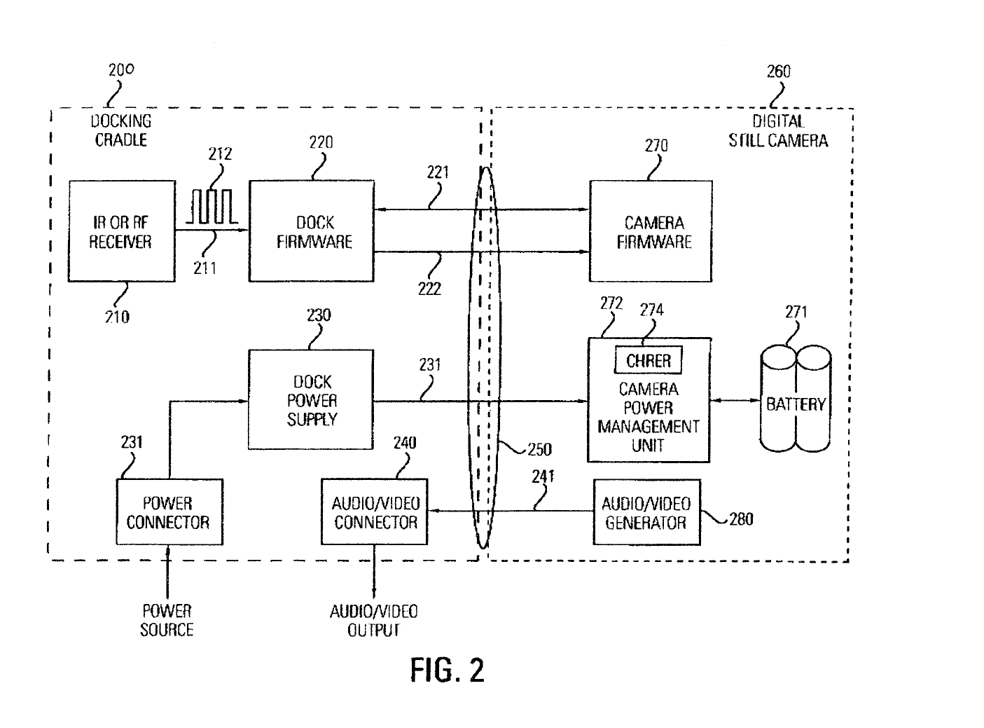

FIG. 2 is block diagram illustrating in greater detail the system 10 of FIG. 1 in accordance with one embodiment of the present invention. The system 10 includes two major components: 1) a docking cradle 200 (also referred to herein simply as dock); and 2) an image capture device 260.

Docking Cradle 200

The docking cradle 200 includes a receiver 210 (e.g., an IR receiver or an RF receiver) that receives commands (e.g., IR commands or RF commands) transmitted by the wireless remote control 46. The docking cradle 200 also includes a power connector 231 for receiving external power from the power source 36, a power management unit 230 for converting the external power into power usable by the receiver 210 and the docking cradle firmware 220. Moreover, as described in greater detail hereinafter, the power management unit 230 can provide power to a docked digital capture device (DCD) 260 via an electrical connection 231 within the mating electrical connector 250. Optionally, the docking cradle 200 includes an A/V cable connector 240 to which an external display may be connected. Audio and/or video signals are transmitted from the DCD 260 via an electrical connection 241 within the mating electrical connector 250.

Digital Capture Device (DCD) 260

The DCD 260 is the second major component of the system 10. The DCD 260 includes firmware 270 that monitors an electrical signal 222, which indicates that the DCD 260 is docked in the cradle 200. The camera firmware 270 can also receive commands from the dock firmware 220 via an electrical communication channel 221. Commands received across this communication channel 221 are interpreted and acted upon by the camera firmware 270. The DCD 260 further includes a power management unit 272 that receives power from the electrical connection 231 to the docking cradle 200 and converts the power for use by the DCD 260. The power management unit 272 ensures that when the DCD 260 is docked in the cradle 200, the power requirements of the DCD 260 are provided through the cradle 200 so that the batteries 271 are not drained, thereby extending the life of the batteries 271.

Furthermore, the power management unit 272 can includes a charger 274 for converting the input power from the docking cradle power supply 230 for use in charging batteries 271 within the DCD 260. The DCD 260 can optionally include audio and video generation circuitry 280 that produces audio and video signals (e.g., visual feedback, audio feedback, or a graphical user interface), which are electrically connected 241 to the ANV connector 240 within the docking cradle 200.

When power is applied to the docking cradle 200, the receiver 210 is capable of receiving users commands from the wireless remote control 46. In response to receiving said commands, the receiver 210 outputs a serial pulse train 212 that represents the command issued by the remote control 46. This pulse train 212 is transmitted to the docking cradle firmware 220 via an electrical connection 211. The dock firmware 220 interprets this pulse train 212 and converts it into one of a number of predefined commands that can be issued by the remote control 46. This command is further transmitted to the docked DCD 260 via the electrical communication channel 221. Upon receiving said transmitted command, the camera firmware 270 performs one or more processing steps associated with the command issued by the remote control 46.

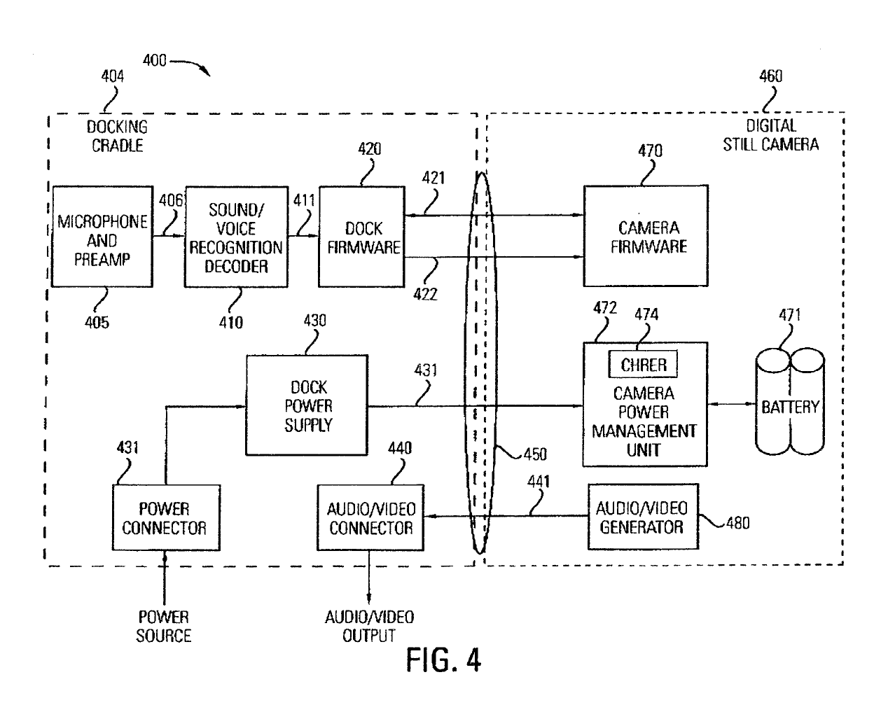

FIG. 4 is a block diagram illustrating an alternative embodiment of a system 400 of the present invention that employs a sound or voice recognition interface. The system 400 includes two major components: 1) a docking cradle 404 (also referred to herein simply as dock); and 2) an image capture device 460.

Docking Cradle 404

The docking cradle 404 includes a microphone and preamplifier 405 and sound/voice recognition decoder 410. The combination of the microphone and preamplifier 405 and the sound/voice recognition decoder 410 receives sound or voice commands issued by a user. The docking cradle 404 also includes a power connector 431 for receiving external power from a power source (e.g., power source 36), a dock power management unit 430 for converting the external power into power usable by the microphone and preamplifier 405, sound/voice recognition decoder 410, and the docking cradle firmware 220.

Moreover, as described in greater detail hereinafter, the dock power management unit 430 can provide power to a docked digital capture device (DCD) 460 (e.g., a digital still camera (DSC)) via an electrical connection 431 within the mating electrical connector 450. Optionally, the docking cradle 404 includes an A/V cable connector 440 to which an external display may be connected. Audio and/or video signals are transmitted from the DCD 460 via an electrical connection 441 within the mating electrical connector 450.

Digital Capture Device (DCD) 460

The DCD 460 is the second major component of the system 400. The DCD 460 includes camera firmware 470 that monitors an electrical signal 422, which indicates that the DCD 460 is docked in the cradle 404. The camera firmware 470 can also receive commands from the dock firmware 420 via an electrical communication channel 421. Commands received across this communication channel 421 are interpreted and acted upon by the camera firmware 470. The DCD 460 further includes a power management unit 472 that receives power from the electrical connection 431 to the docking cradle 404 and converts the power for use by the DCD 460. The power management unit 472 ensures that when the DCD 460 is docked in the cradle 404, the power requirements of the DCD 460 are provided through the cradle 404 so that the batteries 471 are not drained, thereby extending the life of the batteries 471.

Furthermore, the power management unit 472 can include a charger 474 for converting the input power from the docking cradle power supply 430 for use in charging batteries 471 within the DCD 460. The DCD 460 can optionally include audio and video generation circuitry 480 that produces audio and video signals (e.g., visual feedback, audio feedback, or a graphical user interface), which are electrically connected 441 to the A/V connector 440 within the docking cradle 404.

When power is applied to the docking cradle 404, the microphone and preamp 405 are capable of receiving sounds emitted by a user. This sound signal is converted to an electrical signal 406, which is sent to the sound/voice recognition decoder 410. This decoder 410 converts the emitted sound or speech pattern into a command that is transmitted to the dock firmware 420 via an electrical communication channel 411. The dock firmware 420 further transmits this command to the docked DSC 460 via the electrical communication channel 421. Upon receiving said transmitted command, the camera firmware 470 performs one or more processing steps associated with the voice command.

Operation

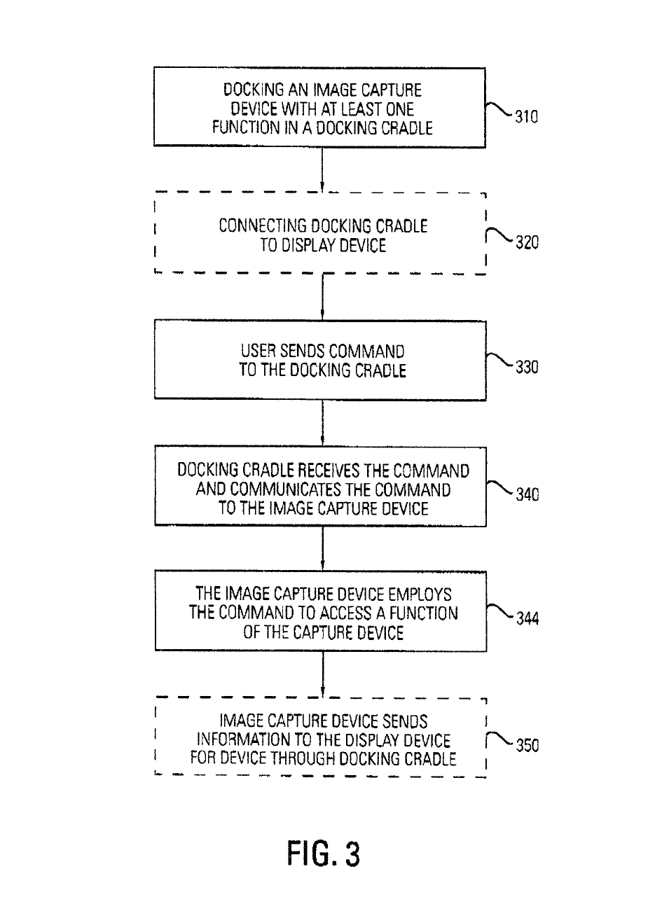

FIG. 3 is a flow chart illustrating the operation of the system of FIG. 1 that employs the docking station to control the digital camera in accordance with one embodiment of the present invention.

In step 310, a digital image capture device that has at least one function (e.g., a function that provides a user feedback or a function that does not provide feedback to the user) is placed into a docking cradle or station. After step 310, step 320 optionally may be performed. In step 320, the docking station is connected to a display device (e.g., a television) through a cable (e.g., an A/V cable). In step 330, a user sends a command to the docking station. For example, the command can be generated from a remote controller or can be a voice or audio command. In step 340, the docking station receives the command and communicates the command to the digital image capture device. In step 344, the digital image capture device employs the command to access a function of the digital image capture device.

After step 344, step 350 optionally may be performed when step 320 has been performed. In step 350, the digital image capture device sends information (e.g., captured images (e.g., pictures) or graphical user interface (GUI) images) to a separate display device (e.g., a television) through the docking station 14. When the docking station 14 is equipped with its own display, the information (e.g., captured images (e.g., pictures) or graphical user interface (GUI) images) may be sent to the docking station display.

In one embodiment, where the image capture device is a digital still camera, and there is either visual or audio feedback that is provided to a user, the following steps may be performed. First, the docking station 14 is connected to a power source and to a display device. Second, the camera 18 is docked in the station 14. Finally, a user can utilize a remote control to access one or more functions of the digital camera 18 through the docking cradle 14.

Although some embodiments described herein refer to a digital still camera (DSC) as the image capture device being controlled, it is to be noted that the docking station method and system of the present invention can be utilized to control other image capture devices, such as digital video cameras, and other digital devices not related to image capture that have at least one function and that can be docked in the docking cradle.

In the foregoing specification, the invention has been described with reference to specific embodiments thereof. It will, however, be evident that various modifications and changes may be made thereto without departing from the broader scope of the invention. The specification and drawings are, accordingly, to be regarded in an illustrative rather than a restrictive sense.

What is claimed is:

1. A method for remotely controlling a digital image capture device that includes at least one function through a docking station when the digital image capture device is docked therein comprising the steps of:
a) docking the digital image capture device in the docking station;
b) sending a command from a wireless remote controller to the docking station;
c) the docking station communicating the command to the digital image ,capture device;
d) the digital image capture device employing the command to access a function of the digital image capture device.

2. The method of claim 1 wherein the function includes a user interface function.

3. The method of claim 2 wherein the user interface function includes one of taking a picture and other functions that do not provide visual feedback.

4. The method of claim 1 wherein the function includes a user interface function that provides one of visual feedback and audio feedback.

5. The method of claim 4 wherein the user interface function that provides visual feedback includes one of viewing pictures, configuring settings of the camera, rotating a displayed picture, deleting a displayed picture, magnifying and panning within a selected picture.

6. The method of claim 1 wherein the visual feedback is provided by the docking station.

7. The method of claim 1 wherein the visual feedback is provided by a separate display device coupled to the docking station.

8. The method of claim 1 wherein the step of the docking station communicating the command to the digital camera includes the step of
decoding the command.

9. The method of claim 1 wherein the step of the docking station communicating the command to the digital camera includes the step of
providing the command directly to the camera without intermediate processing.

10. The method of claim 1 further comprising:
coupling the docking station to a display; and
the digital camera in response to a command to view a picture employing the display to display a picture through the docking station.

11. A docking station for receiving a digital capture device comprising:
a first connector for communicating signals to and from the digital capture device;
a port for receiving at least one command;
a second connector for receiving power;
a first functional block for receiving commands and forwarding the commands to the digital capture device.

12. The docking station of claim 11 further comprising:
a second functional block for receiving at least one signal from the digital image capture device when docked in the docking station and providing feedback to the user at the docking station.

13. The docking station of claim 11 further comprising:
a third connector for providing signals to a separate display device; and
a third functional block for receiving at least one signal from the digital capture device when docked in the docking station and providing the signal to a separate display device through the docking station; wherein the signal may be displayed as one of visual feedback and audio feedback on the separate display device.

14. A system for allowing a user to remotely control a digital camera without wires comprising:
a docking station for receiving a digital camera; wherein the docking station includes a wireless receiver;
a wireless remote controller for sending at least one command to the docking station;
wherein the docking station further includes a communication interface for communicating with the digital camera;
wherein a user can employ the wireless remote controller to control the digital camera through the docking station.

15. The system of claim 14 further comprising:
an audio/video cable for coupling the docking station to a display device.

16. The system of claim 15 wherein the display device is a television.

17. The system of claim 14 further comprising:
a power cord for coupling the docking station to a power source.

18. The system of claim 14 wherein the power source is an AC power source and the power cord includes an AC adapter.

19. The system of claim 14 wherein the receiver includes one of an IR receiver, an RF receiver, an audio receiver, and a visible light receiver.

20. The system of claim 14 wherein the remote controller includes a transmitter; wherein the transmitter includes one of an IR transmitter, an RF transmitter, an audio transmitter, and a visible light transmitter.

21. A system for allowing a user to remotely control a digital image capture device comprising:
a) a docking station for receiving a digital image capture device that has at least one function; wherein the docking station includes a microphone; and a voice recognition decoder coupled to the microphone for receiving at least one voice command;
wherein the docking station further includes a communication interface for communicating with the digital image capture device;
wherein the docking station decodes the received voice command and communicates the decoded voice command to the digital image capture device;
wherein the digital image capture device employs the decoded voice command to access a function of the digital image capture device.
